(19) United States
(12) Patent Application Publication
(10) Pub. No.: US 2003/0208584 A1
(43) Pub. Date: Nov. 6, 2003

(54) Use of world-wire web

(76) Inventor: Cyril John Higgins, Milford (IE)

Correspondence Address: BIRCH STEWART KOLASCH & BIRCH, PO BOX 747, FALLS CHURCH, VA, 22040-0747, US

(21) Appl. No.: 10/275,883

(22) PCT Filed: May 14, 2001
(86) PCT No.: PCT/IE01/00065

(30) Foreign Application Priority Data
May 12, 2000 (IE) S2000/0364

(51) Int. Cl. G06F 15/16

(52) U.S. Cl. 709/223; 709/219

(57) ABSTRACT

A method of storing web site URLs for subsequent retrieval from the WWW comprising using an organisation tree with programmable nodes. The web address is broken down into its constituent parts and each node is used to stored a URL of a web page.

The present invention relates to a method of using the world-wide web (WWW).

As the number of computers increases and as the number of web sites increases, it is becoming more and more difficult for somebody to navigate the whole system. Essentially, what the world-wide web (WWW) is, is a series of interconnected sites locators which are composed of a number of web pages, all of which have unique site details or Uniform Resource (URLs). Not alone do the web pages themselves have URLs but they also can have embedded links or hot links to other web pages. This in turn means that what happens when you visit a site is that you are brought to a particular site which may have links to other sites so that if you are interested in a particular site and you know that it is in some way connected to another site by a link, you can go to that primary site and then, having found the link, find the other site. That is a very cumbersome way of doing it and therefore, if you already knew the address or URL of the site you wish to visit, that would be the correct way to do it. Essentially, there are web sites with only one URL and then other web sits, the most common, which is effectively a composite web site, comprising a base site with its unique bas site address or URL and at least one connected sub-site with its own sub-site sub-address or sub-URL. The composite web site has a composite URL or location URL comprising the base URL and each connected sub-URL.

A site may be revealed by either being visited or simply by being noted in passing.

A further problem is that when navigating the WWW, is that there are many ways that you can arrive at a particular site. For example, you may have typed the URL directly and therefore gone directly to the site or you may have used some form of web browser. No matter what browser you use or no matter how you have arranged or visited a particular site before, you have no record of how you did it and therefore, a user may spend a large amount of time effectively going up blind alleys in the web as they try to find the particular site they are interested in. It is a particularly time consuming task to record all the URLs of the sites visited.

There is undoubtedly a need for some way of sorting out the use of browsers as well as the user sorting out how he or she actually carries out a particular session. The problem essentially is that the user does not know where a particular web page is in relation to all the other web pages he or she may have visited. When a user visits a web page, the user usually has a couple of choices. Either the user wants to visit that web page again or that web page is of no further use to the user, or the web page may be of use in some future period of time. A user should know exactly where that web page is if, at any stage, he may wish to use it in the future. At the same time, he or she does not necessarily want to have to retrace their steps and carry out exactly the same search as before to get at that particular web page. However, at the same time, they know that unless they are carrying out a somewhat similar search, there is no particular advantage in having the particular URL recorded in some way. What is required is that the particular URL be recorded in a way that makes sense to the user. That may be to show the relationship with other sites, it may be that the site needs to be stored in a particular way and so on.

To give a simple example, if somebody is interested in a particular subject and proceeds to do a search of the web to obtain pages that are of interest to him or her, a large number of pages may be produced, many of which are of no use but which, at the same time, have links with other pages that are of use for that particular search in that particular search area. The user may want to store the information that these linked sites are available or these other sites were visited which particular information may not necessarily be needed for that particular search but may indeed be needed for a future search. Therefore, what the searcher wants to do is when, for example, they search a particular subject such as golf and they are only interested in golf clothing, they may also want to get lists of sites where there are other golf items. When the person goes back to look at their golf search heretofore, they say to themselves “the last time round, I was interested in clothing, this time round I am interested in equipment, so I can look at what I have searched before, can eliminate some of those sites I have visited and downloaded before because they are simply clothing and some of the other sites that were not of interest but are linked to it, are of interest to me now because I am interested in equipment”. Also, many people carry out searches and they want to, in some way, tell other people how or why they carried out a particular search or indeed let other people visit exactly the same information and take what they want out of it.

The present invention is directed towards providing a method for increasing the efficiency of the use of the world wide web.

### STATEMENTS OF INVENTION

According to the invention, there is provided a method of recording for subsequent retrieval of web pages of a web site revealed during a search of the world wide web (WWW), the web site having a base site with a unique base address (URL) and at least one connected sub-site with its own sub-address (sub-URL), the web site having a composite URL comprising the base URL and each connected sub-URL as constituent parts of the composite URL comprising:

taking an organisation tree comprising a primary programmable node and subsidiary programmable nodes all linked in a cascading relationship to show the manner in which one node is reached from another, each node being programmed to store a site URL;

breaking the composite URL into its constituent parts, allocating a part and storing its URL at a node in the organisation tree in accordance with its relationship with other parts in the composite URL; and

storing the organization tree with URL containing nodes.

Ideally, subsequently on retrieving the organisation tree, the organisation tree is linked to a web browser and the URL stored at a node is used to command the web browser to retrieve the web page at that site. The organisation tree is preferably graphically displayed on a screen and each node is displayed in the form of an icon for easy retrieval. The graphical representation may be any suitable display device that is hierarchical in nature, for example, the TreeView (Trade Mark) program of control sold by Microsoft, could be one such tool for use in accordance with the invention.

It is envisaged that during a search, on visiting a previously recorded site, the organisation tree previously recorded is displayed and on the input of a command, the two organisation trees are merged.

Preferably, an identifying label is displayed at each node such as the site URL is displayed at each node such as the site URL or it could be a label with a relevance ranking having regard to the search being carried out. It will be appreciated on retrieving an organisation tree, a node is used to retrieve and store the web pages for that site.

The method may further comprise:

preparing an organisation tree comprising a primary node for the base site address and secondary nodes, all linked in a cascading relationship to show the linking of sub-sites by the manner in which sub-sites are reached from the base site and each other, and

programming each node to store for retrieval of the URL of a site assigned thereto.

It is envisaged that on defining an organisation tree for a web site visited, some of the nodes may not be programmed for subsequent retrieval. Further, a plurality of organisation trees are stored under the one search category.

Further, the invention will provide a computer program having program instructions for carrying out the method of the invention which can be loaded into a computer, will constitute the method, it may be embodied on a record medium, a computer memory, a read only memory or on an electrical signal carrier.

### DETAILED DESCRIPTION OF THE INVENTION

The invention will be more clearly understood from the following description of methods according to the invention described with reference to the accompanying drawings, in which:

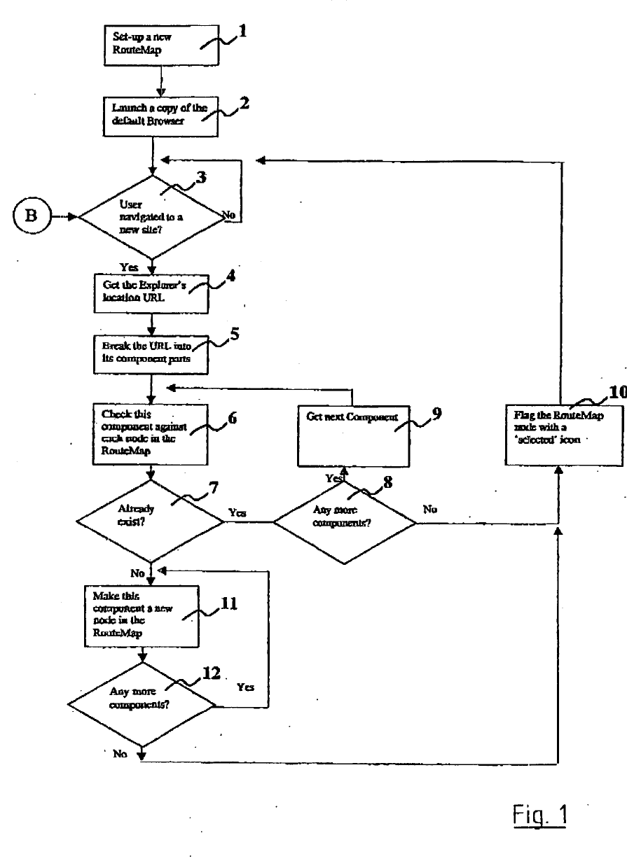

FIG. 1 is a flowchart of a start-up and navigation method according to the invention,

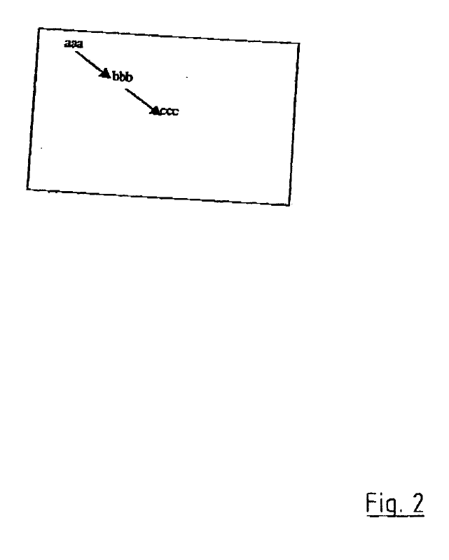

FIG. 2 is a RouteMap according to the invention,

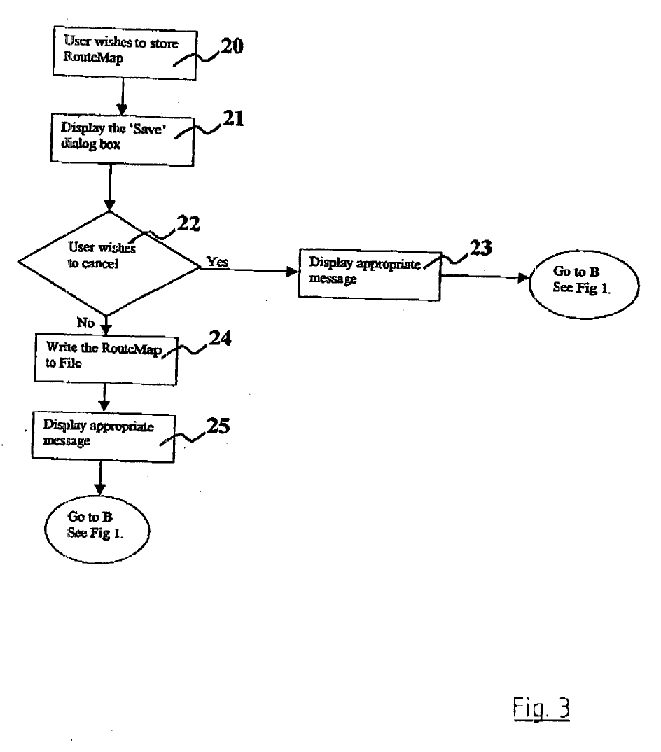

FIG. 3 is a flowchart of the storage of a RouteMap according to the invention,

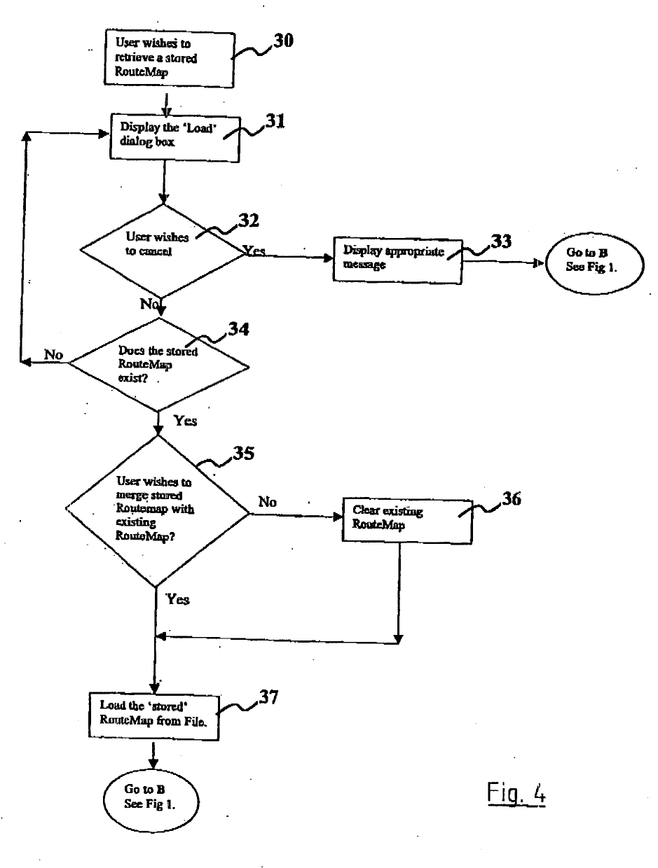

FIG. 4 is a flowchart of the retrieval of a RouteMap according to the invention,

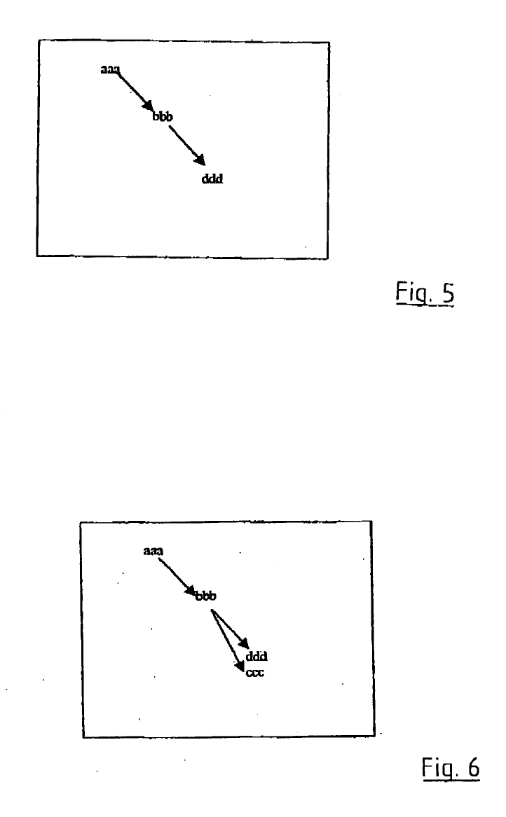

FIG. 5 is a view of a RouteMap according to the invention,

FIG. 6 is a view of another RouteMap according to the invention,

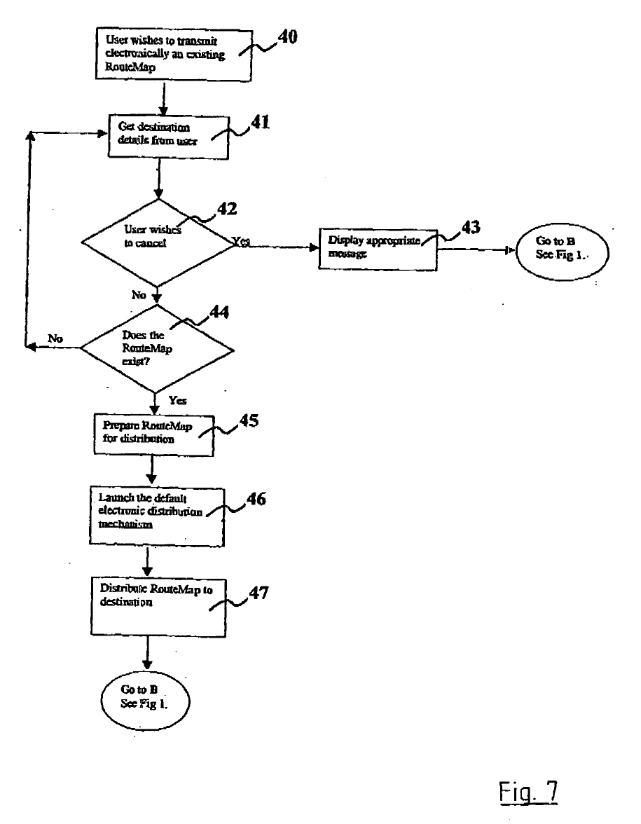

FIG. 7 is a flowchart of the distribution of a RouteMap according to the invention,

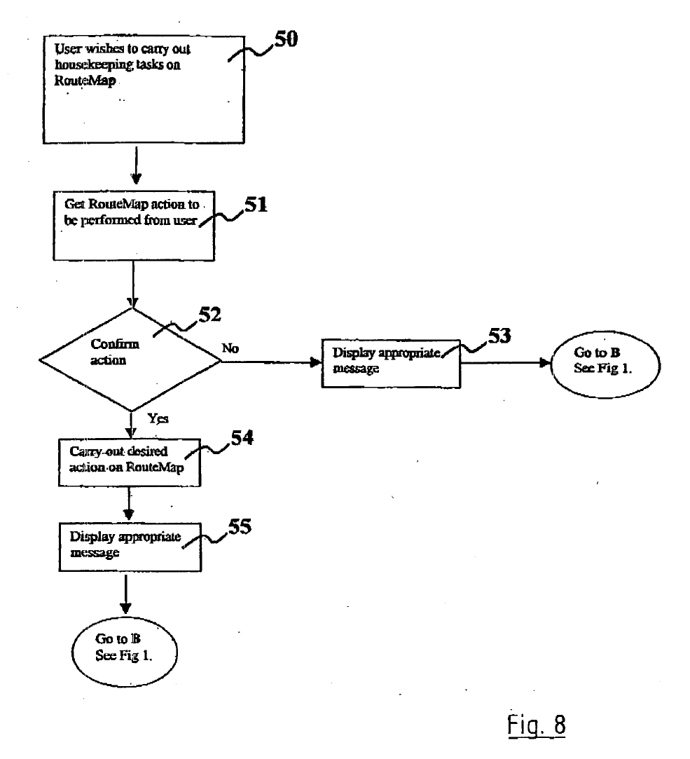

FIG. 8 is a flowchart showing certain tasks carried out in accordance with the invention,

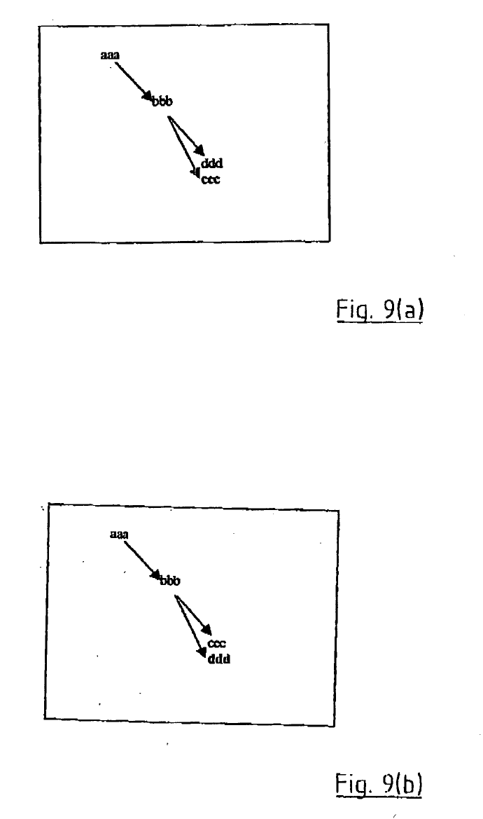

FIGS. 9(a) and 9(b) shows maintenance on a RouteMap,

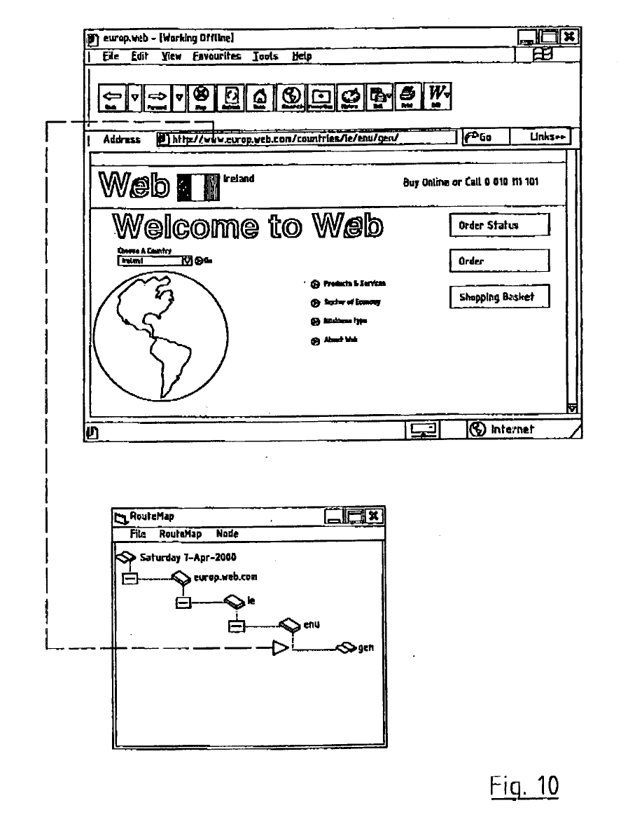

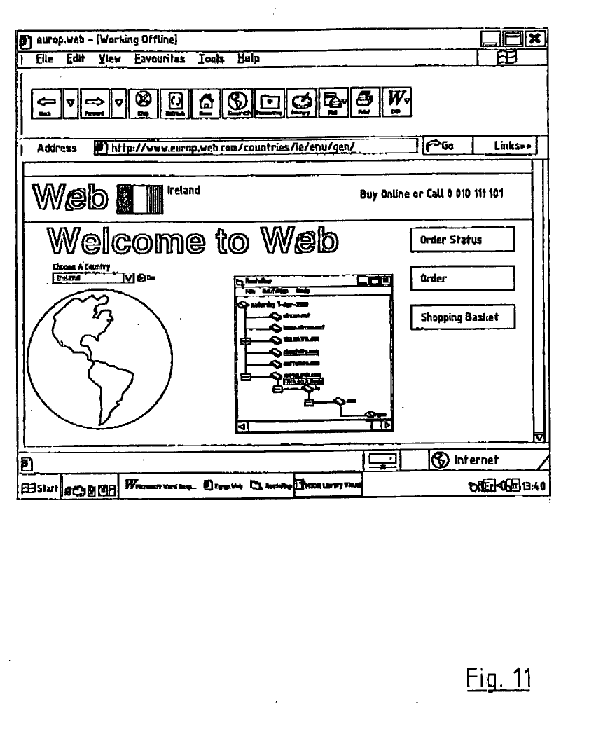

FIG. 10 is a view of a web page showing a particular RouteMap,

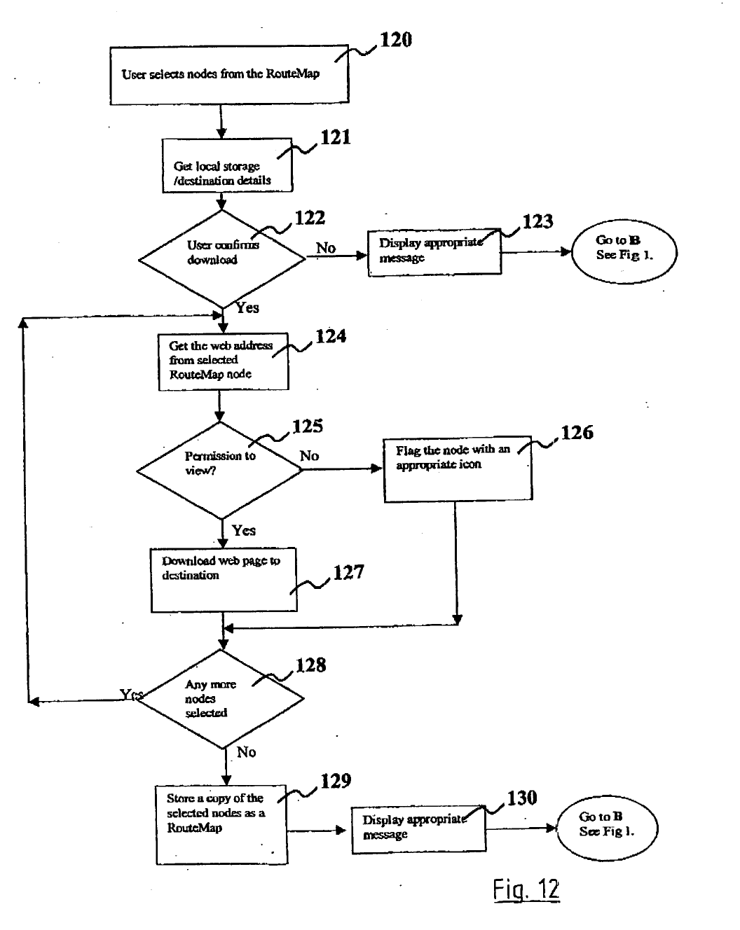

FIG. 11 shows another web page with a RouteMap inset, and

FIG. 12 is a flowchart of the downloading and storage of web pages based on RouteMap node selection according to the invention.

One of the components used in the present invention is the TreeView (Trade Mark) control which is part of the well known Microsoft Windows program. In accordance with the present invention, TreeView control is used and is suitably programmed to work with the present invention. Thus, the present invention uses TreeView to display the RouteMap produced in accordance with the present invention. Essentially, all TreeView is, is a tree consisting of cascading branches and nodes and each node typically consists of an image and a label and thus, for example, it could be the URL of a site. The nodes are expanded or collapsed by way of having children nodes, grandchildren nodes, and so on. Thus, the nodes spread out into an intricate tree somewhat like a tree of descendants. Thus, they show nodes and roots between various parties. In TreeView, each node in the tree is actually a programmable node object which belongs to the node collection. Thus, if a URL is assigned to a particular node, then that particular node, when clicked on to, in accordance with TreeView control, will automatically produce the necessary URL. What the present invention does is to link that node to the program so that the world-wide web page with that particular URL, when that particular node or icon in the display is clicked onto, that particular web page URL will be activated and the page displayed. The purpose of the program is that you can add nodes, take away nodes, and so on. This is the basic tool used in accordance with the invention but does not itself provide the invention. Any other program similar to TreeView could be used to form what is referred to here as a RouteMap.

When somebody wishes to search the world-wide web, the first thing they do is to decide as to whether they wish to set up a RouteMap of that search or not. Presuming they do, then reference is made to FIG. 1. In step 1, the user decides to set up a RouteMap and it step 2, draws down the present invention, i.e. launches a default browser. Then, in step 3, the user navigates to a site and the invention checks as to whether he has navigated to that site before or not. If he has not, then in step 4, presuming it is a new site, the location URL or composite is identified. In step 5, the URL is broken into its component parts. For example, the site visited belonged to the Web corporation, the composite or location URL would be www.euro.web.com/countries/ie/enu/gen/, then there are five components to this address and five nodes will be achieved. This would be viewed by the user as seen in FIG. 10. The invention automatically breaks this down into the five nodes and then in step 6, this is checked against each node in the RouteMap. The next questions to ask is does this node already exist and this is carried out in step 7. If it does, then, in step 8, the question is asked as to whether there are any more components and if there are any more components, in step 9, the additional components are obtained and steps 6 and 7 repeated. It there are no more components, then the use, in this case, of the TreeView control, is used to flag the RouteMap node with a selected icon in step 10 and the user goes back to step 3. If, however, in step 7, the component does not already exist, in step 11, it is made into a new node and again the question is asked, in step 12, are there any more components. If there are not, then again the invention goes back to step 10, and so on. If there are, the invention repeats step 11 by putting in a new component. When all this has been done, a RouteMap such as in FIG. 2 is built up. Thus, for example, as shown in FIG. 2, if the web address is aaa/bbb/ccc, it can be broken down into three components and then, presuming that these have not been seen before, you will get the new RouteMap as shown in FIG. 2. Having prepared this RouteMap, then the user proceeds to decide whether to store the RouteMap or not. FIG. 10, as stated already, shows the RouteMap for www.euro.web.com/countries/ie.enu/gen/.

Referring now to FIG. 3, in step 20, the user decides that he wishes to store the RouteMap and in step 21, the save dialog box is used on the program and in step 22, the user decides to cancel the saving or not. If the user decides to cancel the saving, then in step 23, the appropriate message is displayed and the RouteMap is not saved. If, in step 22, the user decides not to cancel, then in step 24, the RouteMap is written to a file and in step 25, the appropriate message is displayed.

Obviously, when a web site is very small, it may not have any linked pages and thus when revealed can be recorded in conventional manner. It could also be recorded in the same way as any other site in accordance with the invention without any sub-sites being displayed.

Dealing now with a retrieval of a particular search, this is illustrated in FIG. 4. In step 30, the user wishes to retrieve a stored RouteMap. In step 31, the user provides details about the stored RouteMap on the dialog box which then, in step 32, the user has the chance to either cancel, in which case, the appropriate message is displayed in step 33, or the user does not wish to cancel and then the invention queries as to whether the stored RouteMap exists or not in step 34. Presuming that it does exist, in step 35 the user is given the option of merging the stored RouteMap with the existing RouteMap. If the user decides against merging, in step 36 the existing RouteMap is cleared. In step 37 the invention proceeds to load the stored RouteMap. If, by any chance, in step 34, it is found that the RouteMap does not exist, then step 31 is repeated. Let us presume that with the retrieved RouteMap, a new site, the site ccc of FIG. 2, is again recorded but not necessarily visited. In other words, it is noted or revealed. However, when the user retrieves the RouteMap in which aaa and bbb are already there, he may have a RouteMap such as illustrated in FIG. 5. Then, the user will effectively have the RouteMap as in FIG. 2 but because there is already the address ddd because the previous RouteMap gave you aaa/bbb/ddd, then the new URL is entered as an icon in the tree as shown in FIG. 6. It will be appreciated that it is not a question of you having to navigate to any of these sites but merely to have their address, i.e. the sub-URL.

Referring now to FIG. 7, there is shown the steps that the user would use to transmit an existing RouteMap. In step 40, the user decides that he wishes to distribute an electronically existing RouteMap. In step 41, the destination for the transmittal is noted. In step 42, the user decides whether he or she wishes to cancel it or it. If he does, then the appropriate message is displayed in step 43 and the procedure is stopped. If however, the user still wishes to send the RouteMap, the first thing the user then has to do, in step 44, is to decide whether the RouteMap exists. If it does not exist, then the information has to be first prepared before it can be sent. If it does exist, then the RouteMap is prepared in step 45 for distribution and in step 46, the necessary communications procedure is adopted to launch the default electronic distribution mechanism. In step 47, the RouteMap is distributed to the desired address obtained in step 41.

When it is desired to use or revisit a previous search, all that is done is that the RouteMap is downloaded and the user then clicks onto a node on the RouteMap and this will give the URL of the particular web page, whether the base URL or the sub-URL. FIG. 11 illustrates a typical RouteMap the browser would see in the RouteMap window, i.e. where this and similar tasks are carried out. This is then extracted from the node and passed to the relevant browser and the web browser will than navigate to that site. All the user has to do is to click onto a node and the necessary page is downloaded so that it is relatively easy for a searcher to pass back and forth between sites without having to type in URLs, etc. Indeed, if you are searching somebody else's RouteMap, you do not have to know the address at all or you may have already lost the URL. Thus, there is a great advantage in storing a RouteMap for future reload.

One of the things that will always happen is that a RouteMap will need to be altered or maintained. For example, there may be many occasions in which an existing RouteMap may need to be modified for some reason. For example, the user may decide that they no longer require a particular node or number of nodes and this can be shown very clearly where the RouteMap in FIG. 9(a) becomes the Route Map in FIG. 9(b). In steps 50 and 51 (FIG. 8), the user decides that he wants to carry out a particular maintenance or housekeeping duty and obtains a particular RouteMap. This could be to sort a RouteMap, to sort a node, to clear a RouteMap, to remove a node to another place, to remove a node, and so on, i.e. to alter the RouteMap of FIG. 11. The possibilities are endless. In step 52, the user is asked to confirm the action and can decide not to proceed at which case in step 53 the appropriate message is delivered. If the user decides to proceed, in step 54, the invention carries out the desired change to the RouteMap which is then displayed in step 55. For example, there may be occasions where the existing RouteMap may need to be modified for some reason, as explained above. It may be required to remove a node. One of the things that one has to be careful of, is that one cannot wish to maintain children such that, for example, you cannot in the RouteMap of FIG. 6, remove aaa and expect to keep bbb, ddd and ccc. However, you may wish to sort, for example, to make ddd less prominent than ccc and you might, therefore, change the RouteMap of FIG. 6. i.e. as now in the form shown in FIG. 9(a), into the RouteMap of FIG. 9(b). For example, a web browser could be launched by the program, for example, Internet Explorer, the RouteMap window is effectively a floating window. While in the present manifestation of this invention, internet explorer, together with TreeView is used, it will be appreciated that any browser could be used, thus the term “default browser” used above.

In effect, the existing browsing software used is normal and therefore any default browser can be used. Effectively, the present invention attaches to the edge of the browser as it were, and allows one to sort out the particular search carried out by the browser. It is important to remember, as explained above, that the web browser may not have actually navigated to an address but merely have noted it. One of the great advantages is that if a web site has been visited before, one can now look at that web site and decide what other features of the search need to be taken into account because that web site which was visited before can then be amalgamated into the new search if a new tree or RouteMap is to be produced.

Referring now to FIG. 12, the user may decide to download a range of web pages based on a number of selected nodes in the RouteMap. This will allow the user to view the stored web pages at any future date whilst using a stored RouteMap. In step 120 the user has selected a range of nodes on the RouteMap that corresponds to the web pages that he wishes to store. The user provides the invention in step 121, with the destination details for web page storage. In step 122 the user confirms if the invention is to proceed with this action. If not, the appropriate message is displayed in step 123. If the user decides to proceed, then in step 124 the invention extracts the web address from the current RouteMap node. The invention then proceeds to verify whether it is authorised to view the addressed web page in step 125. If not authorised, in step 126 the current node is flagged with a symbol of non-authorisation. If authorised, the web page will be downloaded to its destination in step 127. In step 128 the invention checks whether there are any more selected nodes in the RouteMap. If there are additional nodes selected then step 124 will be repeated. In Step 129, a copy of the selected nodes will be stored, as a RouteMap, at the destination of the web pages. This will be used at a future time when the user wishes to browse through those web pages. The user is provided with appropriate information in step 130, upon completion.

Another great advantage is that when building up a search, one builds up ones own RouteMap, therefore one can decide whether you want to record a particular URL or not. Thus, after having carried out a search which might have visited one hundred sites or at least considered one hundred sites, you may actually only end up with ten relevant sites. Those ten relevant sites are the only sites built into the RouteMap and therefore, if anybody else wants to get the search, then only that RouteMap is displayed with the ten relevant sites. The main thing is that you do not have to go and record all of the sites, addresses, etc. and send them to the third party.

Although the embodiment of the invention described above comprises essentially computers and process performed in computer apparatus, the invention also extends to computer programs, particularly computer programs on or in a carrier adapted for putting the invention into practice. The program may be in the form of source codes, object codes, intermediate source and object codes such as in partially compiled form or in any other form suitable for use in the implementation of the methods according to the invention. The carrier may be any entity or device capable of carrying the program.

For example, the carrier may comprise a storage medium such as a ROM, for example, a CD ROM or a semiconductor ROM, or a magnetic recording medium, for example, a floppy disk or hard disk. Further, the carrier may be a transmittable carrier such as an electrical or optical signal which may be conveyed via electrical or optical cable or by radio or other means. When the program is embodied in a signal which may be conveyed directly by a cable or other device means, the carrier may be constituted by such cable or other device or means.

Alternatively, the carrier may be an integrated circuit in which the program is embedded, the integrated circuit being adapted for performing or for use in the performance of the relevant processes.

The invention will be carried out on a personal computer or any other device which is capable of being connected to the www which will allow the person operating it to surf the net.

In the specification the terms “comprise, comprises, comprised and comprising” or any variation thereof and the terms “include, includes, included and including” or any variation thereof are considered to be totally interchangeable and they should all be afforded the widest possible interpretation.

The invention is not limited to the embodiments hereinbefore described but may be varied in both construction and detail.

1. A method of recording for subsequent retrieval of web pages of a web site revealed during a search of the world wide web (WWW), the web site having a base site with a unique base address (URL) and at least one connected sub-site with its own sub-address (sub-URL), the web site having a composite URL comprising the base URL and each connected surf-URL as constituent parts of the composite URL comprising:
taking an organisation tree comprising a primary programmable node and subsidiary programmable nodes all linked in a cascading relationship to show the manner in which one node is reached from another, each node being programmed to store a site URL;
breaking the composite URL into its constituent parts, allocating a part and storing its URL at a node in the organisation tree in accordance with its relationship with other parts in the composite URL; and
storing the organisation tree with URL containing nodes.

2. A method as claimed in claim 1, in which subsequently on retrieving the organisation tree, the organisation tree is linked to a web browser and the URL stored at a node is used to command the web browser to retrieve the web page at that site.

3. A method as claimed in claim 1 or 2, in which the organisation tree is graphically displayed on a screen and each node is displayed in the form of an icon for easy retrieval.

4. A method as claimed in any preceding claim, in which during a search, on visiting a previously recorded site, the organisation tree previously recorded is displayed and on the input of a command, the two organisation trees are merged.

5. A method as claimed in claim 3 or 4, in which an identifying label is displayed at each node.

6. A method as claimed in claim 4 or 5, in which the site URL is displayed.

7. A method as claimed in claim 5 or 6, in which the label is provided with a relevance ranking having regard to the search being carried out.

8. A method as claimed in any preceding claim, in which on retrieving an organisation tree, a node is used to retrieve and store the web pages for that site.

9. A method as claimed in any preceding claim, comprising:
preparing an organisation tree comprising a primary node for the base site address and secondary nodes, all linked in a cascading relationship to show the linking of sub-sites by the manner in which sub-sites are reached from the base site and each other; and
programming each node to store for retrieval of the URL of a site assigned thereto.

10. A method as claimed in any preceding claim, in which additionally on defining an organisation tree for a web site visited, some of the nodes may not be programmed for subsequent retrieval.

11. A method as claimed in any preceding claim, in which a plurality of organisation trees are stored under the one search category.

12. A computer program having program instructions for causing a computer to perform the method of any of claims 1 to 11.

13. A computer program comprising program instructions which when loaded into a computer constitute the method carried out in any of claims 1 to 11.

14. A computer program as claimed in claims 12 or 13 embodied on a record medium.

15. A computer program as claimed in claims 12 or 13 stored in a computer memory.

16. A computer program as claimed in claims 12 or 13 embodied in a read only memory.

17. A computer program as claimed in claims 12 or 13 carried on an electrical signal carrier.

18. A method substantially as hereinbefore described with reference to and as illustrated in the accompanying drawings.
